(19) United States
(12) Patent Application Publication
(10) Pub. No.: US 2007/0236718 A1
(43) Pub. Date: Oct. 11, 2007

(54) Apparatus and method for managing a printed document and apparatus for managing information

(76) Inventors: Katsuya Yokomura, Yokohama (JP); Ken Kobayashi, Machida (JP); Toshiyuki Morita, Yokohama (JP); Minoru Tokunaga, Yokohama (JP); Junichi Matsuda, Higashimurayama (JP); Yukio Ide, Atami (JP); Tadafumi Tatewaki, Shimizu (JP); Tatsuro Saitoh, Sagamihara (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/699,995

(22) Filed: Jan. 31, 2007

(30) Foreign Application Priority Data
Feb. 2, 2006 (JP) 2006-025891

(51) Int. Cl. B41B 1/02

(52) U.S. Cl. 358/1.13

(57) ABSTRACT

An apparatus for managing a printed document includes a storage medium capable of reversibly storing and erasing information, a printing/erasure device for executing printing to the storage medium and erasing a printed record, a document management server for managing information and security of the information, a write device for adding information onto the storage medium, and a monitor device for monitoring takeout of a printed document. A storage medium ID for identifying an individual medium is imparted to each medium. When printing, write, etc, are performed to the storage medium, the document management server manages the storage medium ID and a security level of a printed document file. The monitor device gives a warning not to take out the printed document in accordance with the security level of the document when the storage medium of printed documents is to be taken out.

### CLAIM OF PRIORITY

The present application claims priority from Japanese application serial no. 2006-025891 filed on Feb. 2, 2006, the content of which is hereby incorporated by reference into this application.

### BACKGROUND OF THE INVENTION

This invention relates to an apparatus for managing a printed document, a method for managing a printed document and an information management apparatus. More particularly, the invention relates to a printed document management apparatus, a printed document management method and an information management apparatus each capable of preventing leak of information printed on a reversible storage medium when storage, erasure and write are made to the reversible storage medium.

Protection of personal information and security information of enterprises has become very important in recent years within the limit where the value of enterprises is not lowered. Therefore, several vendors have offered setups that allow company staffs outside an office or on an official trip to assuredly gain access to electronic documents from outside the company or to conduct document security management while the electronic documents are held inside the company.

US2005/017914 (JP-A-2005-259108) as an example of the prior art relating to a document security management system for managing document security teaches to employ a server for securely managing documents in this system so that the security condition of the documents can be traced and maintained even under the state where printing, reproduction, etc, of the documents are repeated. This document security management system according to the prior art includes an image formation apparatus and a security server connected to the image formation apparatus through a network. The security server includes a first profile management table for generating and storing a profile of an electronic document when the image formation apparatus generates the electronic document, and a second profile management table for generating and storing a profile of a printed document in association with an ID of a document of an origin of the printed document when the image formation apparatus generates the printed document. When the printed document is outputted, the image formation apparatus buries a new print ID into the printed document and prints the document.

The prior art described above can manage printing onto a sheet surface and duplication of documents printed onto the sheet. However, this prior art cannot be applied to a reversible storage medium capable of erasing printed documents and printing other documents. More concretely, because the prior art does not have a function of setting a security level of information written once to the sheet, it cannot keep the security level of the information written once. In addition, the prior art cannot keep the level of the security level after rewrite owing to its function of setting the security level of information rewritten to the sheet.

The prior art described above manages individual documents by associating electronic documents with printed documents by using the document profile management table and the print profile management table but when the printing content on the sheet is changed, matching of this association is lost. In consequence, leak of information cannot be prevented when the information printed onto the sheet is the one that is printed onto an information rewritable sheet.

### SUMMARY OF THE INVENTION

It is an object of the invention to provide a printed document management apparatus, a printed document management method and an information management apparatus each capable of preventing leak of information printed onto a reversible storage medium.

According to one aspect of the invention, there is provided an apparatus for managing a printed document comprising a storage medium capable of reversibly storing and erasing information; a storage/erasure device for storing or erasing information to or from the storage medium; an information management device for managing information and security of the information; and a write device for adding information onto the storage medium; wherein the information management device includes a storage device for managing information stored by the storage/erasure device to the storage medium or information added by the write device; means for updating the information of the storage device at the time of storage of the information; and means for updating the information of the storage device when the information is rewritten.

According to another aspect of the invention, there is provided a method for managing a printed document in an apparatus for managing a printed document including a storage medium capable of reversibly storing and erasing information; a storage/erasure device for storing or erasing information to or from the storage medium; an information management device for managing information and security of the information; and a write device for adding information onto the storage medium; the method comprising the steps of storing or erasing information to or from the storage medium by the storage/erasure device; writing information to the storage medium by the write device; and updating the information held inside at the time of storing, erasing and rewriting of the information by the information management device.

More concretely, the invention includes means for comparing a security level of information printed before write with a security level of information printed after write, setting the highest security level to the security level of the printed document and calculating in this way the security level of the storage medium as a whole.

When the printed document is rewritten, the invention sets once again the security level of the information before rewrite that has already been set to a storage medium ID of the printed storage medium surface to the security level of the information after rewrite, and can thus prevent leak of the information printed onto the storage medium surface.

In the invention, write and rewrite frequently occur in the same printed document and the security level is thereby changed. For this reason, the security level of the printed document cannot be easily deciphered by users of the printed document and ease-of-use is not much high for the users. Therefore, a symbol or a character capable of deciphering the security level is printed onto the printed document.

The invention makes it possible to prevent leak of information printed onto a reversible storage medium.

Other objects, features and advantages of the invention will become more apparent from the following description of the embodiments of the invention taken in conjunction with the accompanying drawings.

### BRIEF DESCRIPTION OF THE DRAWINGS

FIG. 1 is a flowchart useful for explaining a basic processing operation of a document managing apparatus according to an embodiment of the invention;

FIG. 2 is a block diagram showing a construction of the document managing apparatus according to the embodiment of the invention;

FIG. 3 is a table showing a record construction of document condition information dealt with in the embodiment of the invention and an example of data corresponding to each record;

FIG. 4 is a table showing a record construction of document information dealt with in the embodiment of the invention and an example of data corresponding to each record;

FIG. 5 is a table showing a record construction of write information dealt with in the embodiment of the invention and an example of data corresponding to each record;

FIG. 6 is a table showing a record construction of security content setting information dealt with in the embodiment of the invention and an example of data corresponding to each record;

FIG. 7 is a table showing a record construction of area information dealt with in the embodiment of the invention and an example of data corresponding to each record;

FIG. 8 is a flowchart useful for explaining in detail the processing of the steps 11 to 12 explained with reference to the flowchart of FIG. 1;

FIG. 9 is a flowchart useful for explaining in detail an updating processing of document condition information 3 of the step 89 explained with reference to the flowchart of FIG. 8;

FIG. 10 is a flowchart useful for explaining in detail the processing of the steps 13 to 14 explained with reference to the flowchart of FIG. 1;

FIGS. 11A, 11B and 11C are flowcharts useful for explaining in detail a processing for setting a security level of the write information of the step 103 explained with reference to the flowchart of FIG. 1;

FIG. 12 is a flowchart useful for explaining in detail an updating processing of the document condition information 3 of the step 103 explained with reference to the flowchart of FIG. 10;

FIG. 13 is a flowchart useful for explaining in detail a processing for calculating a security level of an overall storage medium of a reversible storage medium 250 of the step 124 explained with reference to the flowchart of FIG. 12;

FIG. 14 is a flowchart useful for explaining in detail the processing of the steps 15 to 16 explained with reference to the flowchart of FIG. 1;

FIG. 15 is a flowchart useful for explaining in detail an updating processing of information of the document condition information 3 of the step 1410 explained with reference to the flowchart of FIG. 14;

FIG. 16 is a flowchart useful for explaining in detail the processing of the step 17 explained with reference to the flowchart of FIG. 1;

FIG. 17 shows a display example of a warning screen of “No Takeout” that is displayed by using a warning display function portion 233 in the processing of the step 168 shown in FIG. 16;

FIG. 18 is a flowchart useful for explaining a processing operation for printing a security level symbol onto a reversible storage medium; and

FIG. 19 shows a printing example of a symbol representing the security level to the reversible storage medium printed in the step 184 in the flow shown in FIG. 18.

### DESCRIPTION OF THE EMBODIMENTS

Apparatus and method for managing a printed document and an apparatus for managing information according to preferred embodiments of the invention will be hereinafter explained in detail.

The embodiments of the invention that will follow are concerned with an information management apparatus including a storage medium capable of reversibly storing and erasing information, a storage/erasure device for the reversible storage medium to which printing is made, an information management server for managing information and security of the information and a write device for adding information to the reversible storage medium. The storage/erasure device includes means for storing information to the reversible storage medium and means for erasing the information from the reversible storage medium and the information management server includes means for updating information of a server and means for updating information of the server when the information is rewritten. The write device includes means for writing the information to the reversible storage medium.

The definition of the terms used for explaining the invention will be explained before the explanation of the embodiments of the invention is started.

The term “write” means that information is afresh inputted to the reversible storage medium to which information has already been stored, by using the storage/erasure device, a marker, and so forth.

The term “revision” means one of means for accomplishing “write” that inputs new information by using a marker to the reversible storage medium to which information has already been stored.

The term “marker” means a ball-point pen, an aqueous or oily pen, a black pencil, a color pencil and so forth, and may include means for optically reading an image.

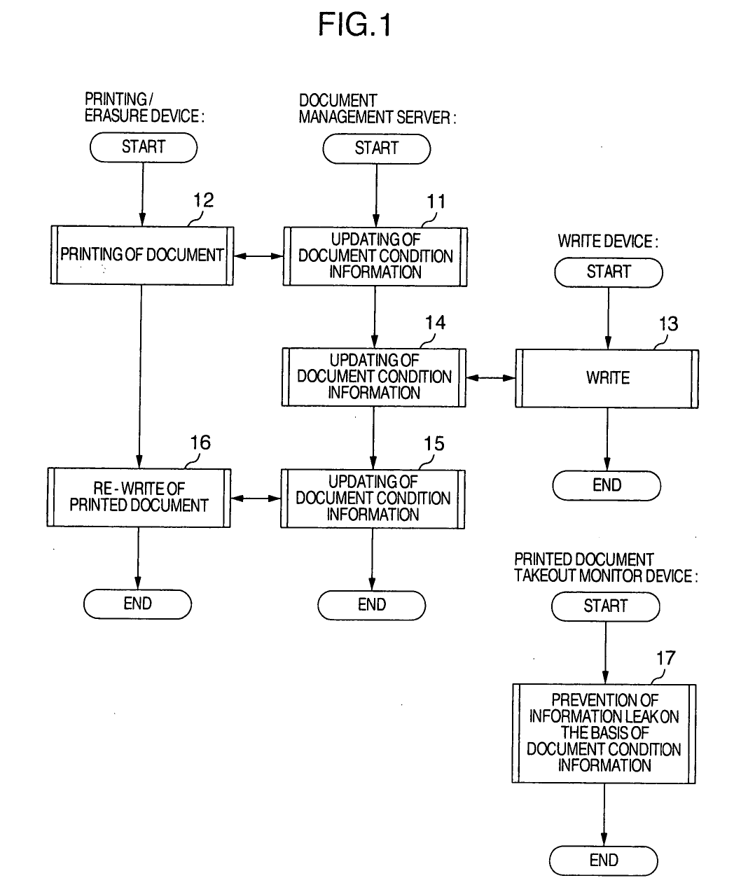

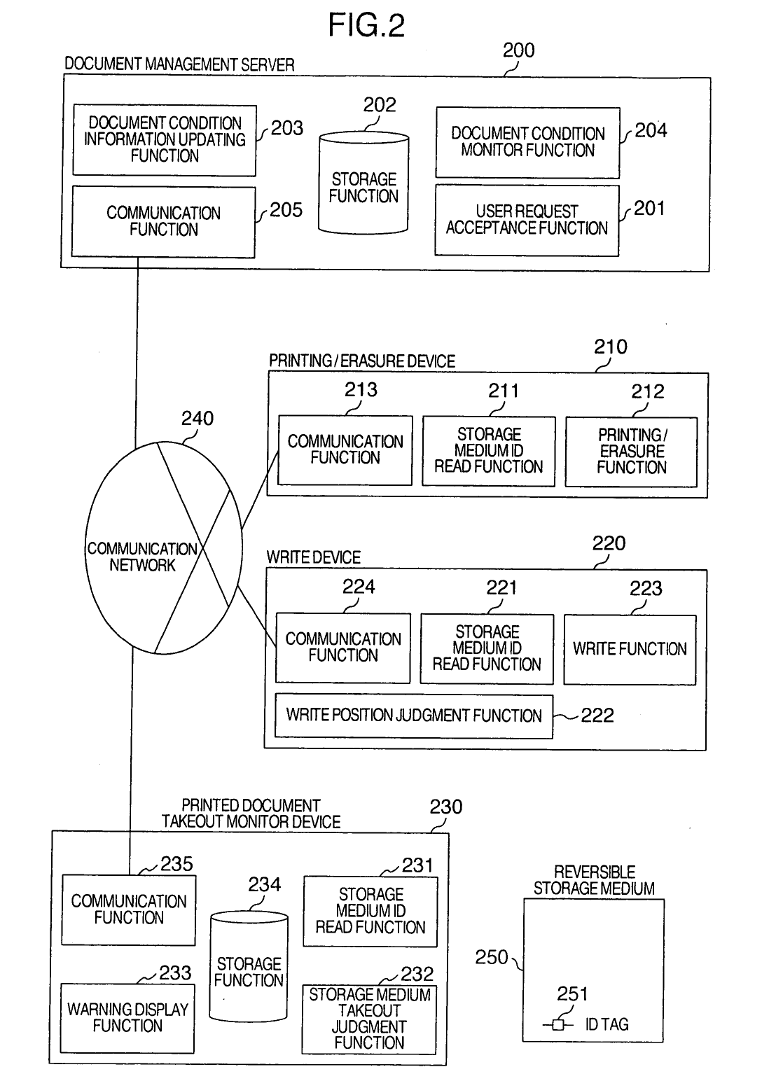

FIG. 1 is a flowchart useful for explaining a basic processing operation of a document managing apparatus according to an embodiment of the invention and FIG. 2 is a block diagram showing a construction of the document managing apparatus according to the embodiment of the invention. Referring to FIG. 2, reference numeral 200 denotes a document management server, reference numeral 201 denotes a user request acceptance function portion, reference numerals 202 and 234 denote storage function portions, reference numeral 203 denotes a document condition information updating function, reference numeral 204 denotes a document condition monitor function portion, reference numerals 205, 213, 224 and 235 denote communication function portions, reference numeral 210 denotes a printing/erasure device, reference numerals 211, 221 and 231 denote storage medium ID read function portions, reference numeral 212 denotes a printing/erasure function portion, reference numeral 220 denotes a write device, reference numeral 222 denotes a write position judgment function portion, reference numeral 223 denotes a write function portion, reference numeral 230 denotes a printed document takeout monitor device, reference numeral 232 denotes a storage medium takeout monitor judgment function portion, reference numeral 233 denotes a warning display function portion, reference numeral 240 denotes a communication network and reference numeral 250 denotes a reversible storage medium.

The document management apparatus according to one embodiment of the invention includes the document server 200 as an information management device for managing information stored onto a storage medium, the printing/erasure device 210 for storing or erasing the information to or from the storage medium, the write device 220 for executing a write operation of information to the storage medium and a printed document takeout monitor device 230 all of which are connected to the communication network 240 as shown in FIG. 2. Though the server described above and three devices are shown connected through the communication network in the embodiment shown in FIG. 1, all these members may be gathered into one set of information processing unit.

In the construction described above, the document management server 200 includes five members, that is, the user request acceptance function portion 201, the storage function portion 202, the document condition information updating function portion 203, the document condition monitor function portion 204 and the communication function portions 205. The printing/erasure device 210 includes three members, that is, the storage medium ID read function portion 211, the printing/erasure device 212 and the communication function portion 203. The write device 220 includes four function portions, that is, the storage medium ID read function portion 221, the write position judgment function portion 222, the write function portion 223 and the communication function portion 224. The printed document takeout monitor device 230 includes five function portions, that is, the storage medium ID read function portion 231, the storage medium takeout judgment function portion 232, the warning display function portion 233, the storage function portion 234 and the communication function portion 235. These function portions are allowed to perform necessary functions by hardware of a later-appearing apparatus and a program for controlling the hardware.

Each of the document management server 200, the printing/erasure device 210, the write device 220 and the printed document takeout monitor device 230 includes an information processing unit having a CPU and each function of the function portions of each of these devices is exhibited when the CPU provided to each device executes a program.

The first function of the document management server 200 is a function as a user interface for a manager managing the document management server 200 and users. The input operation from the manager and users is executed through an input device such as a mouse or a keyboard and the output operation to the users is executed through an output device such as a display for displaying a screen or a speaker generating sound. The user request acceptance function portion 201 includes the input device, the output device and a program for controlling the execution of the input and output devices.

The second function of the document management server 200 is a function of storing information handled in the document management server 200 by the storage function portion 202.

The third function of the document management server 200 is a function of the document condition information updating function portion 230 for keeping the information about the document condition stored in the storage function portion 202 inside the document management server 200 under the latest condition. The document condition information updating function portion 203 updates the document condition information on the basis of the updating event from the user request acceptance function portion 201 and the communication network 240.

The fourth function of the document management server 200 is a function of the document condition monitor function portion 204 for monitoring the document condition on the basis of the information about the document condition stored in the storage function portion 202. The document condition monitor function portion 204 whether or not the document condition hits a predetermined condition and generates a display request of information representing in a sense the “occurrence of problem” to the user request acceptance function portion 201 when this condition is hit.

The fifth function of the document management server 200 is a function of the communication function portion 205 for transmitting and receiving information necessary for the document management server 200 to communicate with the printing/erasure device 210, the write device 220 and the printed document takeout monitor device 230 through the communication network 240.

The first function of the printing/erasure device 210 is a function of the storage medium ID read function portion 211 for reading an ID of the storage medium for printing or erasing the printing content by using the printing/erasure device 210.

The second function of the printing/erasure device 210 is a function of the printing/erasure device 21 for printing or erasing the printing content to or from the reversible storage medium.

The third function of the printing/erasure device 210 is a function of the printing/erasure function portion 210 for transmitting and receiving information for communicating with the document management server 200 and the printed document takeout monitor device 230 through the communication network 240.

The first function of the write device 220 is a function of the storage medium ID read function portion 221 for reading an ID of the storage medium for executing write by using the write device 220.

The second function of the write device 220 is a function of the write position judgment function portion 222 for judging the position of the storage medium to which write is made by the write device 220.

The third function of the write device 220 is a function of the write function portion 223 for executing write to the reversible storage medium.

The fourth function of the write device 220 is a function of the communication function portion 224 for transmitting and receiving information for the write device 220 to communicate with the document management server 200, the printing/erasure device 210 and the printed document takeout monitor device 230 through the communication network 240.

The first function of the printed document takeout monitor device 230 is a function of the storage medium ID read function portion 221 for reading the ID of the storage medium when the storage medium passes through the printed document takeout monitor device 230.

The second function of the printed document takeout monitor device 230 is a function of the storage medium takeout judgment function portion 232 for judging whether or not takeout of the storage medium is permitted when the storage medium passes through the printed document takeout monitor device 230.

The third function of the printed document takeout monitor device 230 is a function of the warning display function portion 233 for raising an alarm to takeout of a person taking out the storage medium by a display device such as a display or a sound generation device such as a speaker when the storage medium passes through the printed document takeout monitor device 230 and when the storage medium takeout judgment function portion 232 judges that takeout of the storage medium is “not permitted”.

The fourth function of the printed document takeout monitor device 230 is a function of the storage function portion 234 for storing information to be handled by the printed document takeout device 230.

The fifth function of the printed document takeout monitor device 230 is a function of the communication function portion 235 for transmitting and receiving information for the printed document takeout monitor device 230 to communicate with the document management server 200, the printing/erasure device 210 and the write device 220 through the communication network 240.

The reversible storage medium 250 has an electronic tag 251 for storing a storage device ID incorporated onto the storage medium 250 during production as a first device. The embodiment of the invention assumes that the electronic tag 251 stores the storage medium ID. However, it is possible in the invention to employ a construction in which a pattern for judging the ID is printed to a part or the whole surface of the reversible storage medium 250 and the storage medium ID read function portion 221 calculates the numerical value from the pattern and can take it out as the ID instead of the electronic tag. The reversible storage medium 250 is those storage media the storage of which can be changed by applying heat or irradiating light from outside the media. The “reversible storage medium” will be hereinafter explained.

Those materials which cause mainly the change of a color condition typified by thermo-chromism, photo-chromism and electro-chromism the colors or color tones of which change by stimuli of heat, laser, light, voltage, current, etc, are used as a reversible storage material used for the reversible storage medium capable of reversibly storing and erasing the information. The change of the color condition includes the changes of transmission factor, reflection factor, absorption wavelength, scattering coefficient, and so forth and actual reversible storage materials execute display by the combinations of these changes. Next, concrete examples of the reversible storage medium will be explained but the embodiment of the invention is not limited to them.

(1) Reversible Storage Materials Using the Change of Color or Color Tone Due to Stimulus of Heat:

The following materials are known as the reversible storage medium the color tone of which changes with the change of thermal energy or laser energy applied.

A first example is the one in which a layer prepared by dispersing particles of an organic low molecular weight material in a resin matrix is disposed on a support and which utilizes a physical change such as transparency/turbidity.

A second example is a dye type reversible storage medium and examples of the dye type reversible storage medium include a reversible storage medium using the combination of gallic acid with fluoroglycinol as a developer, a reversible storage medium using a compound such as phenolphthalein or thymolphthalin, a reversible storage medium the recording layer of which contains a homogeneous compatible compound of a coloring agent, a developer and a carboxylic acid ester, a reversible storage medium using an ascorbic acid derivative for the developer, a reversible storage medium using a salt between bis(hydroxyphenyl)acetic acid or gallic acid and a higher aliphatic amine and a reversible storage medium using an electron donor compound having a long chain aliphatic group for the developer.

A third example is a liquid crystal type reversible storage medium that utilizes the change of a cholesteric liquid crystal compound from the cholesteric liquid phase to a non-cholesteric liquid crystal phase. In a recording material consisting of a cholesteric liquid crystal compound or its mixture, a reversible storage medium capable of keeping a reflected color at normal temperature for a long time when it is rapidly cooled from the cholesteric liquid crystal state and capable of repeatedly making storage when it is returned to the liquid crystal state; and a reversible storage medium consisting of a thermo-tropic liquid crystal compound forming the cholesteric liquid crystal phase, forming the cholesteric glass phase solidifying the spiral molecular arrangement of the cholesteric liquid crystal phase when the thermo-tropic liquid crystal compound is heated to a temperature for forming an isotropic phase or the cholesteric liquid crystal phase, and cooling it at a specific cooling rate.

(2) Those Reversible Storage Materials which Utilize a Reversible Storage Material the Color or Color Tone of which Changes by Stimulus of Light:

The following are known as the reversible storage media the color or color tones of which changes due to the stimulus of light.

As a reversible storage medium the color tone of which changes with the change of energy of light, a reversible storage medium which causes a photo-chromic compounds of all colors to emit colors by a UV lamp for a mixture of three kinds of photo-chromic fulgide compounds of yellow, magenta and cyan under the light emission state, and selectively distinguishes the colors by irradiating visible light of wavelength range corresponding to the maximum absorption wavelength of each photo-chromic compound that generates its color; and a reversible storage medium which is prepared by stacking on a substrate two or more kinds of light sensitive layers containing in each layer a photo-chromic compound having a different maximum absorption wavelength and a different absorption edge wavelength under a light emission state, and which enters the light emission state by the irradiation of the UV light and under the distinguished state by the irradiation of visible light.

The reversible storage material used for the reversible storage medium described above may be disposed at a part or the whole surface of the medium or may be disposed on the surface and/or the back.

The shape of the support and its structure and size are not limited, in particular and can be suitably selected in accordance with the object. The shape is a flat sheet, for example, and the structure may be a single-layered structure or a stacked structure. The size may be selected suitably in accordance with the size of the reversible heat sensitive storage medium.

The material of the support described above includes an inorganic material and an organic material. Concrete examples of the inorganic material include glass, silica, silicon, silicon oxide, aluminum oxide, SiO₂ and metals. Concrete examples of the organic material include paper, cellulose derivatives such as cellulose triacetate, synthetic paper, polyethylene terephthalate, polycarbonate, polystyrene, polymethyl methacrylate, and so forth. These materials may be used either singly or in combination of two or more kinds.

To improve bondability of the coating layer, the surface of the support described above may be modified by corona discharge treatment, oxidation reaction treatment (chromic acid, etc), etching treatment, easy bonding treatment, antistatic treatment, and so forth. The support may be whitened by adding a white color pigment such as titanium oxide.

The thickness of the support is not limited, in particular, but can be selected suitably in accordance with the object. For example, the thickness is preferably from 1 to 2,000 μm, more preferably 5 to 1,000 μm, further preferably 10 to 300 μm and most preferably 15 to 200 μm.

The support may have a magnetic heat sensitive layer on at least one of the surfaces that is the same as the heat sensitive layer and the opposite surface. The reversible heat sensitive storage medium used in the invention may be bonded to other media through a tackifier layer.

Various kinds of information handled in the embodiments of the invention will be explained prior to the explanation of the detail of each function of the printed document managing apparatus and its operation.

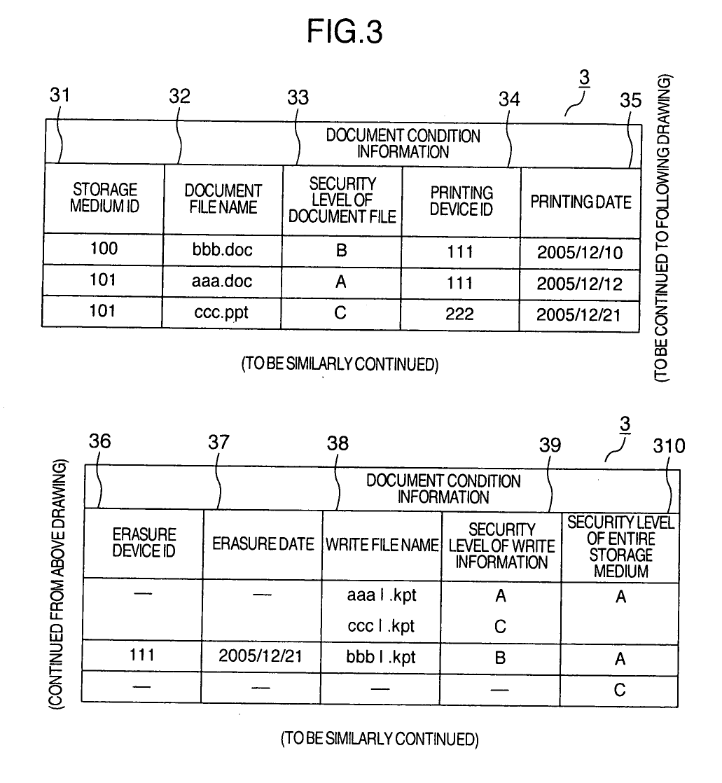

FIG. 3 shows a record construction of document condition information handled in the embodiment of the invention and an example of data corresponding to each record. The document condition information shown in FIG. 3 is stored in the storage function portion 202 of the document management server 200 shown in FIG. 2.

As shown in FIG. 3, the document condition information 3 includes a record 31 of the storage medium ID for storing the ID of the storage medium for primarily identifying the storage medium, a record 32 of a document file name for storing the file name of the information of the document printed onto the storage medium, a record 33 of a security level of the document file for storing the security level of the document file stored in the record 32 of the document file name, a record 34 of a printer ID storing the ID of the printer for primarily identifying the printer printing the document file stored in the record 32 of the document file name to the storage medium of the storage medium ID stored in the record 31 of the storage medium ID, a record 35 of a printing date for storing printing date, i.e. year-month-day, on which the document file stored in the record 32 of the document file name to the storage medium of the storage medium ID stored in the record 31 of the storage medium ID, a record 36 of an erasing device ID storing ID for primarily identifying an erasing device that erases the document file stored in the record 32 of the document file name from the storage medium of the storage medium ID stored in the record 31 of the storage medium ID, a record 37 of erasing year-month-day storing the year, month and day on which the document file stored in the record 32 of the document file name is erased from the storage medium of the storage medium ID stored in the record 31 of the storage medium ID, a record 38 of a write file name storing the file name storing the information that is written by the write device onto the storage medium of the storage medium ID stored in the record 31 of the storage medium ID, a record 39 of a security level of the write information storing the security level of the write file stored in the record 38 of the write file name, and a record 310 of the security level of the entire storage medium storing the security level of the entire storage medium stored in the record 31 of the storage medium 1D.

When write occurs a plurality of times, the write file name is added to the record 38 of the write file name in the document condition information described above whenever write is made. Consequently, a plurality of write file names can be stored. When a plurality of write files exists, a plurality of security levels is stored to the record 39 of the security level of the write information in match with each write file.

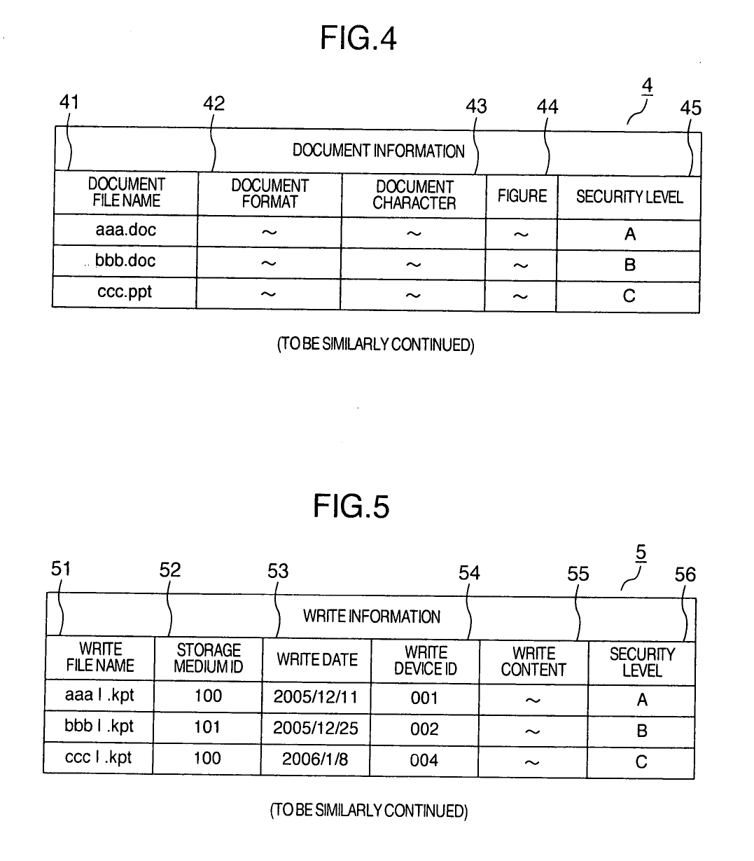

FIG. 4 shows a record construction of the document information handled in the embodiment of the invention and an example of data corresponding to each record. The document information shown in FIG. 4 is stored in the storage function portion 202 of the document management server 200 shown in FIG. 2.

As shown in FIG. 4, the document information 4 includes a record 41 of a document file name storing the file name of the document, a record 42 of a document format storing the format of the document of the document file stored in the record 41 of the document file name, a record 43 of a document character storing character information of the document of the document file stored in the record 41 of the document file name, a record 44 of a figure storing the figure of the document of the document file stored in the record 41 of the document file name and a record of a security level storing the security level of the document of the document file stored in the record 41 of the document file name.

FIG. 5 shows a record construction of the write information handled in the embodiment of the invention and an example of data corresponding to each record. The write information shown in FIG. 2 is stored in the storage function portion 202 of the document management server 200 shown in FIG. 2.

As shown in FIG. 5, the write information 5 includes a record 51 of a write file name for managing the written information, a record 52 of a storage medium ID storing the ID of the reversible storage medium 250 to which write is made, a record 53 of a write date for storing the year-month-date on which write is made, a record 54 of the write device ID storing the information for primarily distinguishing the device that executes write, a record 55 of a write content storing the written content, and a record of a security level storing the security level of the written information.

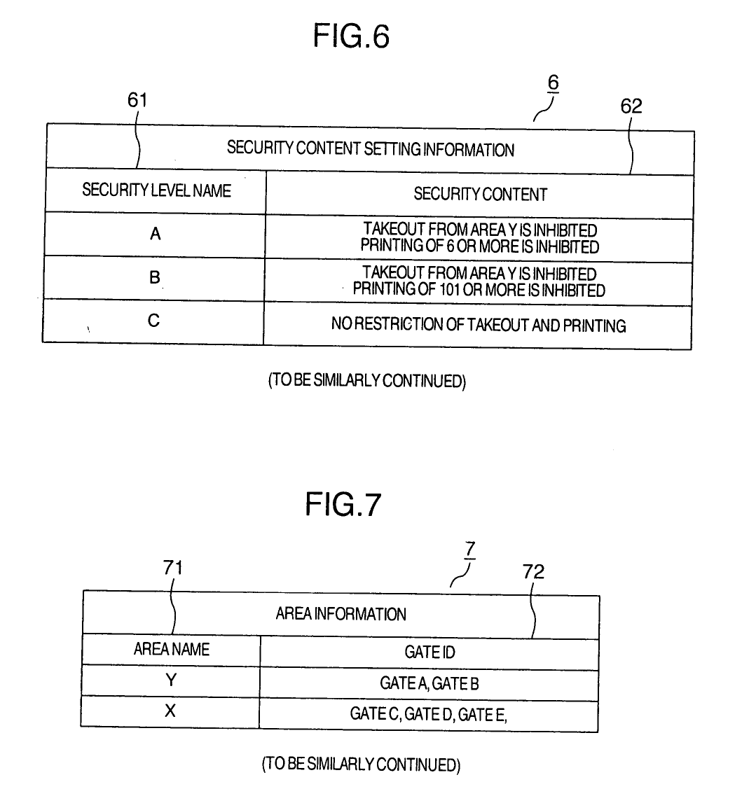

FIG. 6 shows a record construction of the security content setting information handled in the embodiment of the invention and an example of data corresponding to each record. The security content setting information shown in FIG. 6 is stored in the storage function portion 234 of the printed document takeout monitor device 230.

As shown in FIG. 6, the security content setting information includes a record 61 of a security level name storing the name of the security level and a record 62 of the security content storing limit information of the document for securing security.

FIG. 7 shows a record construction of area information handled in the embodiment of the invention and an example of data corresponding to each record. The area information shown in FIG. 7 is stored in the storage function portion 234 of the printed document takeout monitor device 230.

As shown in FIG. 7, the area information 7 includes a record 71 of an area name storing the name of the area and a record of a gate ID storing the names of entrance/exit of the area for defining the area of the record 71 of the area name.

Next, the basic processing operation of the document management apparatus according to the embodiment of the invention will be explained with reference to the flowchart shown in FIG. 1.

In the embodiment of the invention, the document management server 200 executes the processing of each of the steps 11, 14 and 15 as shown in FIG. 1 and the printing/erasure device 210 executes the processing of each of the steps 12 and 16. The write device 220 executes the processing of the step 13 and the printed document takeout monitor device 230 executes the processing of the step 17. These kinds of processing will be hereinafter explained serially.

(1) The document management server 200 transmits the printing request of the information to the printing/erasure device 210, receives the event of printing completion from the printing/erasure device 210 and updates the document condition information 3 (step 11).

(2) The printing/erasure device 210 receives the printing request transmitted in the processing of the step 11, executes printing to the reversible storage medium 250 in accordance with the information printing request and transmits the event of printing completion to the document management server 200 (step 12).

(3) On the other hand, the write device 200 executes write of the information to the reversible storage medium 205 and transmits the ID of the storage medium to which write is made and the information written to the document management server 200 (step 13).

(4) The document management server 200 receives the ID of the storage medium which is transmitted and written by the processing of the step 13 and updates the document condition information 3 (step 14).

(5) The document management server 200 transmits the erasure request of the printed information of the reversible storage medium 250 and a new information printing request to the printing/erasure device 210, receives the event of erasure completion and the event of printing completion from the printing/erasure device 210 and updates the document condition information 3 (step 15).

(6). The printing/erasure device 210 receives the erasure request of the printing information transmitted by the processing of the step 15 and the new information printing request, executes the erasure and printing to meet with the request to the reversible storage medium 250 and transmits the event of erasure completion and the event of printing completion to the document management server 200 (step 16).

(7) The printed document takeout monitor device 230 serially monitors takeout of the reversible storage medium 250 on the basis of the document condition information, judges whether or not takeout of the reversible storage medium 250 is permitted, displays warning representing that takeout is not permitted when takeout is judged as inhibited, and prevents leak of the information (step 17).

The embodiment of the invention explained with reference to FIGS. 1 and 2 uses one each printing/erasure device 210, write device 220, printed document takeout monitor device 230 and reversible storage medium 250 for the ease of explanation but may also use a plurality of printing/erasure devices 210, a plurality of write devices 22 and a plurality of printed document takeout monitor devices 230, and a large number of reversible storage media 250.

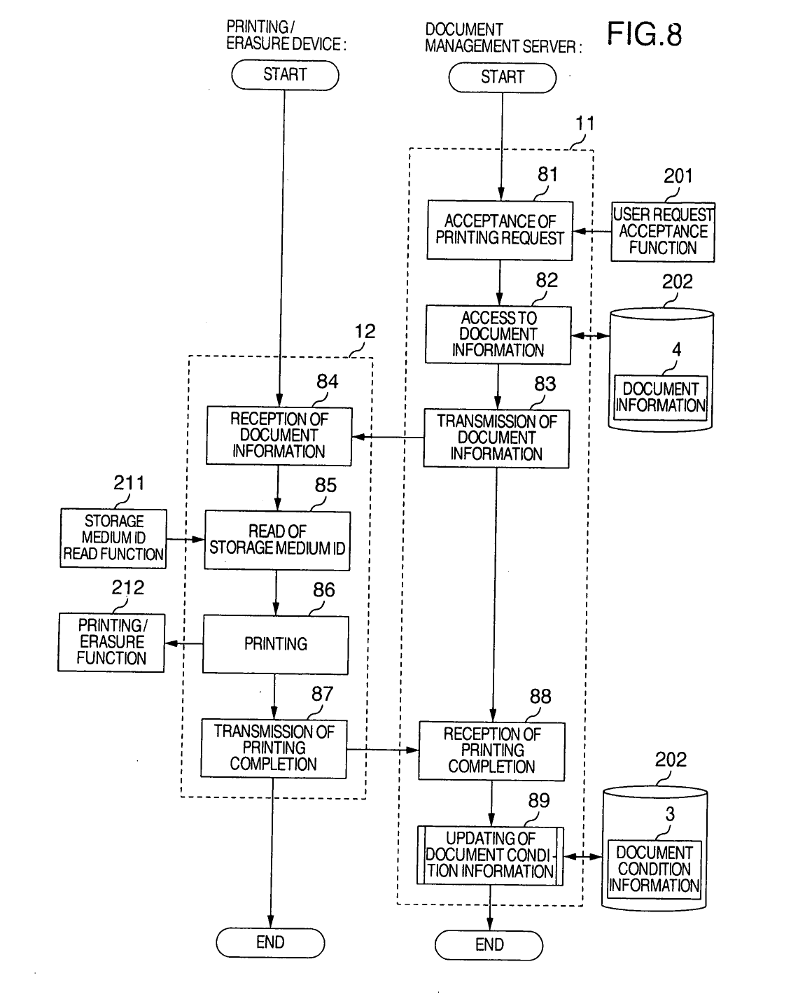

FIG. 8 is a flowchart useful for explaining the detail of the processing of the steps 11 and 12 that have been explained with reference to the flowchart of FIG. 1. Next, the processing will be explained. This processing covers the following processing. Namely, the document management server 200 transmits the information printing request to the printing/erasure device 210, the printing/erasure device 210 then executes printing to the reversible storage medium 250 to meet with the printing request of the information received, and transmits the event of printing completion to the document management server 200, and the document management server 200 receives the event of printing completion from the printing/erasure device 210 and updates the document condition information 3.

(1) The document management server 200 accepts the printing instruction from the user request acceptance function portion 201 and the information for retrieving the document information of the document stored in the storage function portion 202 such as the file name of the document (step 81).

(2) The document management server 200 gains access to the document from the document information 4 stored in the storage function portion 202 on the basis of the information accepted in the step 81. More concretely, the document management server 200 retrieve the document file name 41 of the document information 4 by using the document file name received by the processing of the step 81 as a key and reads out a document format 42, a document character 43, a FIG. 44 and a security level 45 as the information of the document (step 82).

(3) The document management server 200 transmits the printing instruction received by the processing of the step 81 and the information read from the storage function portion 202 by the processing of the step 82 to the printing/erasure device 210 through the communication network 240 (step 83).

(4) The printing/erasure device 210 receives the information sent from the document management server 200 by the processing of the step 83 through the communication network (step 84).

(5) The printing/erasure function portion 210 reads the ID of the storage medium to be printed from the recognition tag 251 put to the reversible storage medium 250 by using the storage medium ID function portion 211 (step 85).

(6) After completion of printing, the printing/erasure device 210 transmits the event of printing completion, the storage medium ID of the reversible storage medium 250 printed, the printing device ID, the printing date and the printed document file name to the document management server 200 through the communication network 240 (step 86).

(7) After printing is completed, the printing/erasure device 210 transmits the event of printing completion, the storage medium ID of the reversible storage medium 250 printed, the printing device ID, the printing date and the printed document file name to the document management server 200 through the communication network 240 (step 87).

(8) The document management server 200 receives the information transmitted from the printing/erasure device 210 by the processing of the step 87 through the communication network 240 (step 88).

(9) The document management server 200 updates the information of the document condition information 3 stored in the storage function portion 202 on the basis of the printing/erasure device 210 received by the processing of the step 88 (step 89).

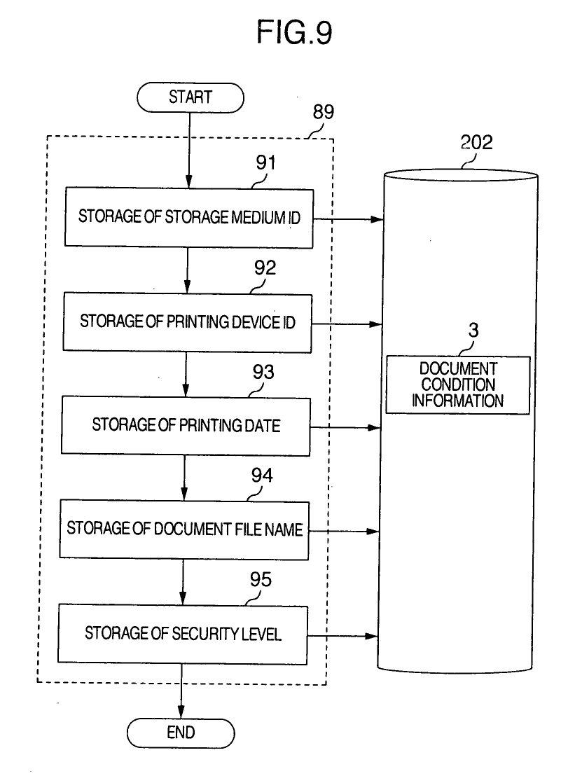

FIG. 9 is a flowchart useful for explaining the detail of the updating processing of the information of the document condition information 3 of the step 89 explained with reference to the flowchart of FIG. 8. Next, the updating processing will be explained.

(1) The document management server 200 saves the storage medium ID received by the processing of the step 88 in the storage medium ID of the document condition information 3 stored in the storage function portion 202 and also stores the printing device ID received by the processing of the step 88 in the printing device ID 32 (step 91).

(2) The document management server 200 saves the printing date received by the processing of the step 88 in the printing date 33 of the document condition information 3 and the document file name received by the processing of the step 88 in the document file name 36 (steps 93 and 94).

(3) The document management server 200 further saves the security level read by the processing of the step 82 in the security level 37 of the document file of the document condition information 3 stored in the storage function portion 202 (step 95).

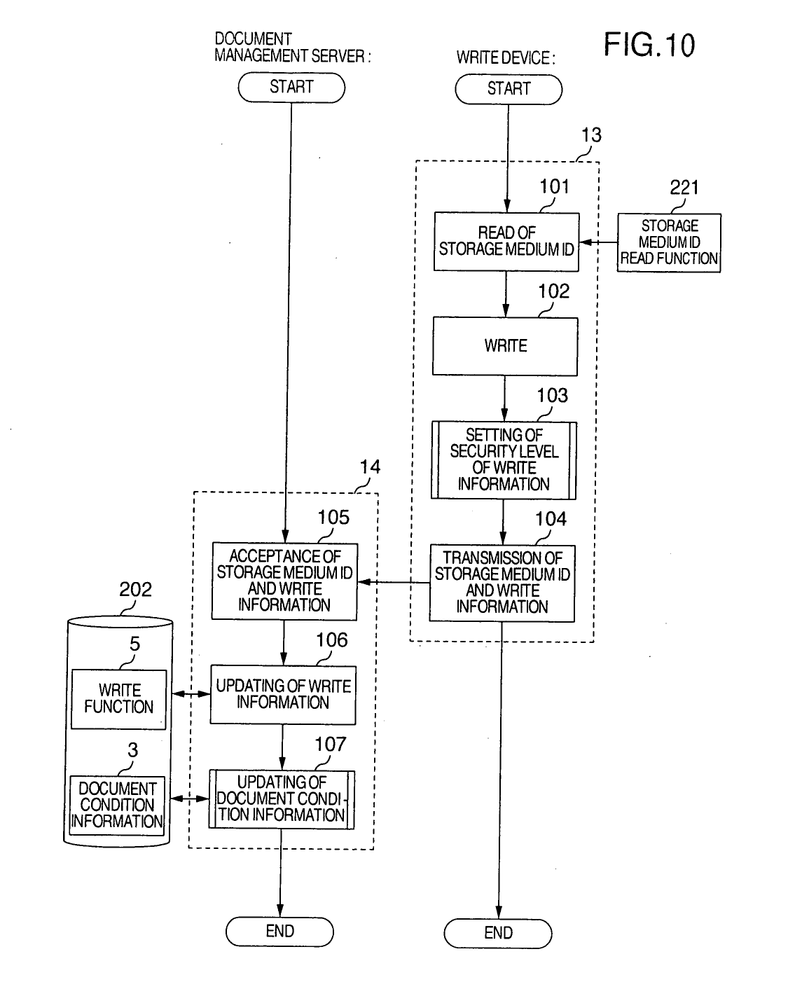

FIG. 10 is a flowchart useful for explaining the detail of the updating processing of the information of the document condition information 3 of the steps 13 and 14 explained with reference to the flowchart of FIG. 1. Next, this processing will be explained. This is the processing that executes write of the information by the write device 220 to the reversible storage medium 205 and transmits the ID of the written storage medium and the written information to the document management server 200, and the document management server 200 receives the ID of the written storage medium and the written information and updates the document condition information.

(1) The write device 220 reads the storage medium ID of the reversible storage medium 250 by using the storage medium ID read function portion 221. More concretely, a pattern for discriminating the ID is printed to the entire surface or a part of the surface of the reversible storage medium 250, the storage medium ID read function portion 221 calculates a numerical value from this pattern and takes out the value as the ID. Alternatively, the storage medium ID read function portion 221 reads the storage medium ID from the identification tag 251 (step 101).

(2) The write device 220 executes write of the information to the reversible storage medium 250 and sets the security level of the written information. The detail of the processing for setting the security level will be later described (steps 102 and 103).

(3) The write device 220 transmits the storage medium ID read by the processing of the step 101, the write date, the ID of the device written, the information written by the processing of the step 102 and the security level set by the processing of the step 103 to the document management server 220 through the communication network (step 104).

(4) The document management server 200 receives the storage medium ID, the write date, the ID of the written device, the written information and the security level of the information through the communication network 240 (step 105).

(5) The document management server 200 stores the information received and written by the processing of the step 105 in the write information 5 stored in the storage function portion 202 and updates the write information 5. More concretely, the document management server 200 generates the write file whenever write occurs and stores it in the write file name 51. The document management server 200 also stores the storage medium ID, the write date, the write ID, the written information and the security information of the information that are received by the processing of the step 105, into the storage medium ID 52, the write date 53, the write device ID 54, the write content 55 and the security level 56, respectively (step 106).

(6) The document management server 200 thereafter updates the document condition information 3 stored in the storage function portion 202. The detailed processing of updating the document condition information 3 will be later described (step 107).

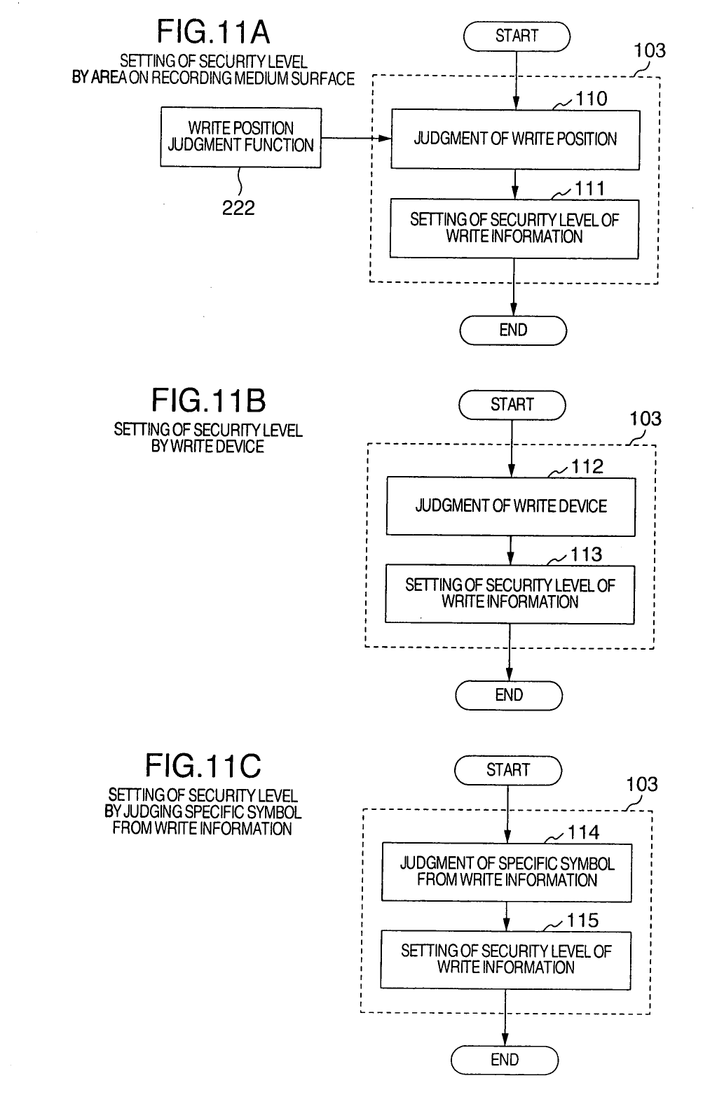

FIGS. 11A, 11B and 11C are flowcharts useful for explaining the detail of the processing for setting the security level of the write information of the step 103 explained with reference to the flowchart of FIG. 1. The detail of this processing will be explained next. In this embodiment, three methods of setting the security level of the write information will be explained. The first and third methods of setting the security level of the write information assume that the write device has a pen form.

The first method shown in FIG. 11A is a setting method by an area on the surface of the storage medium of the reversible storage medium. For this method, the reversible storage medium 250 is divided in advance into several areas. When the reversible storage medium is a letter of application, for example, it is divided into an area for describing a name and an address, an area for describing an application content, and so forth. Each area is defined by X-Y coordinates on the surface of the storage medium. The security level is in advance determined for each of the areas so divided. For example, the area for describing the name and the address and the area for describing the application content are set beforehand to “A” and “B”, respectively. According to the first method, to which position the write operation is made is judged by the write device 220 and the security level of the write information written to that position is decided. When write is made to the area of the address in the example given above, the security level of the written information to that position is “A” and when write is made to the area of the application content, the security level of the written information to that position is “B”. Therefore, the processing by the first method is executed by the processing of the step 110 in which the write position judgment function portion 222 judges the position information to which the write function portion 223 writes the information and the processing of the step 111 in which the security of the write information is decided from the judgment result of the position by the processing of the step 110.

The second method shown in FIG. 11B is a setting method of the security level of the write device ID. For this method, the security level is so set in advance as to correspond to each write device 220. For example, the security level of the write information written by the write device having the write device ID “001” is in advance set to “A” and the security level of the write information written by the write device having the write ID “002” is in advance set to “B”. Therefore, the processing by the second method is executed by the processing of the step 112 of reading the write device ID that executes write and the processing of the step 113 of setting the security level of the write information from the write device ID.

The third method shown in FIG. 11C is the method that sets the security level by discriminating a specific symbol from the write information. For this method, a security level associated with a specific symbol is set when the information written from the write device contains the specific symbol. When the symbol “⊚” exists in the write information, the security level is set to “A”. When “Δ” exists, on the other hand, the security level is set to “B”. Therefore, the processing by the third method is executed by the processing of the step 114 of extracting the specific symbol from the write information written by the write device 220 and discriminating the symbol and the processing of the step 115 of setting the security level that is in advance associated with the symbol discriminated by the processing of the step 114. Incidentally, characters written by pens can be recognized at present and character recognition can be made by experts or technicians in this field. Therefore, its explanation will be hereby omitted.

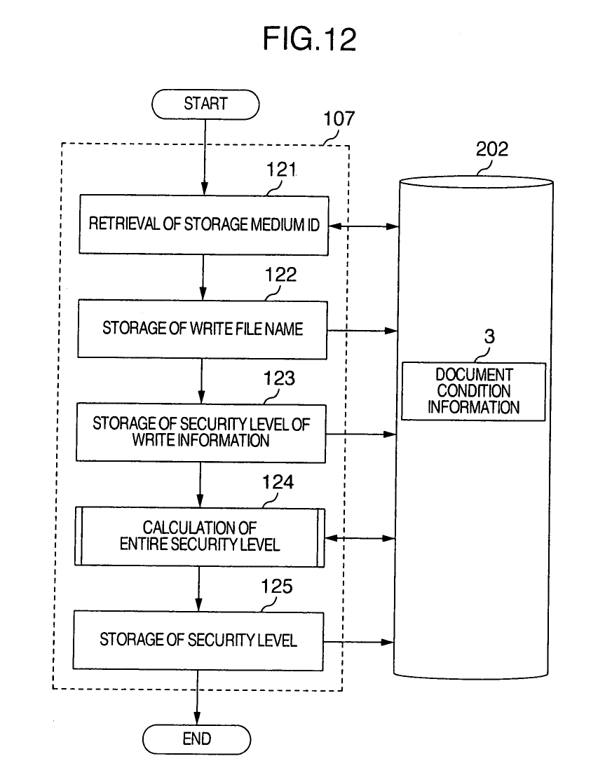

FIG. 12 is a flowchart useful for explaining the detail of the updating processing of the information of the document condition information 3 of the step 107 explained with reference to the flowchart of FIG. 10. The updating processing will be explained next.

(1) The document management server 200 retrieves the document condition information from the storage medium ID 31 in the document condition information 3 stored in the storage function portion 202 by using the storage medium ID received from the write device 220 in the processing of the step 105 in FIG. 10 as a key (step 121).

(2) Next, the document management server 200 stores the write file name received from the write device 220 by the processing of the step 105 in FIG. 10 to the write file name 38 of the document condition information 3 stored in the storage function portion 202 (step 122).

(3) The document management server 200 stores the security level of the write information received from the write device 220 by the processing of the step 105 in FIG. 10 to the security level 39 of the write information of the document condition information 3 stored in the storage function portion 202 (step 123).

(4) The document management server 200 thereafter reads out the security level 37 of the document file from the document condition information 3 stored in the storage function portion 202 and the security level 39 of the write information and calculates the security level of the entire storage medium of the reversible storage medium 250 from these security levels. The detail of this processing will be explained elsewhere in detail (step 124).

(5) The document management server 200 stores the security level of the entire storage medium of the reversible storage medium 250 calculated by the processing of the step 124 into the security level 310 of the entire storage medium of the document condition information stored in the storage function portion 202 (step 125).

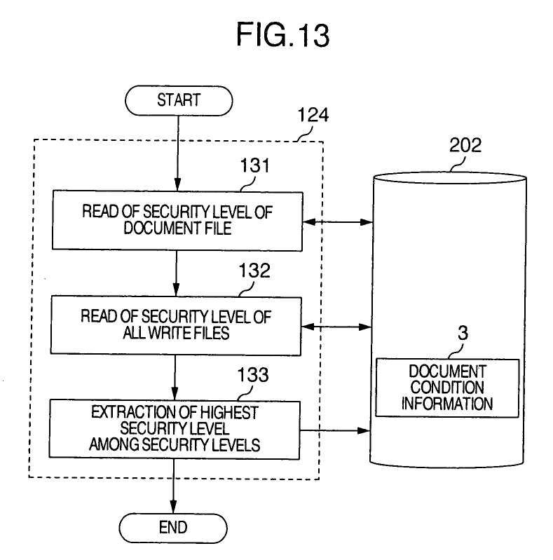

FIG. 13 is a flowchart useful for explaining the detail of the processing of calculating the security level of the entire storage medium of the reversible storage medium 250 of the step 124 explained with reference to the flowchart of FIG. 12, and this processing will be explained next.

(1) The document management server 200 reads the security level of the document file from the security level 33 of the document file of the document condition information stored in the storage function portion 202 by using the storage medium ID received from the write device 220 in the processing of the step 105 of the flow shown in FIG. 10 as a key. In the example shown in FIG. 3, the value “B” of the security level of the document file is read by using the storage medium ID “100” from the document condition information 3 when the storage medium ID is “100” (step 131).

(2) Next, the document management server 200 reads the security level of the write information from the security level 39 of the write information of the document condition information 3 stored in the storage function portion 202 by using the storage medium ID received from the write device 220 in the processing of the step 105 of the flow shown in FIG. 10 as a key. In the example shown in FIG. 3, the value “A” of the security level of the write file “aaal.kpt” and the value “C” of the security level of the write file “cccl.kpt” are read from the document condition information 3 by using the storage medium ID “100” as a key when the storage medium ID is “100” (step 132).

(3) The security level of the document file read in the processing of the step 131 and the security level of the document file read in the processing of the step 132 are compared and the highest security level is extracted. In the example shown in FIG. 3, three security levels, that is, the security level “A” of the document file and the security levels “A” and “C” of the write file, are compared and the highest security level proves “A” by assuming that A has a higher security level than C. Therefore, the security level “A” is extracted (step 133).

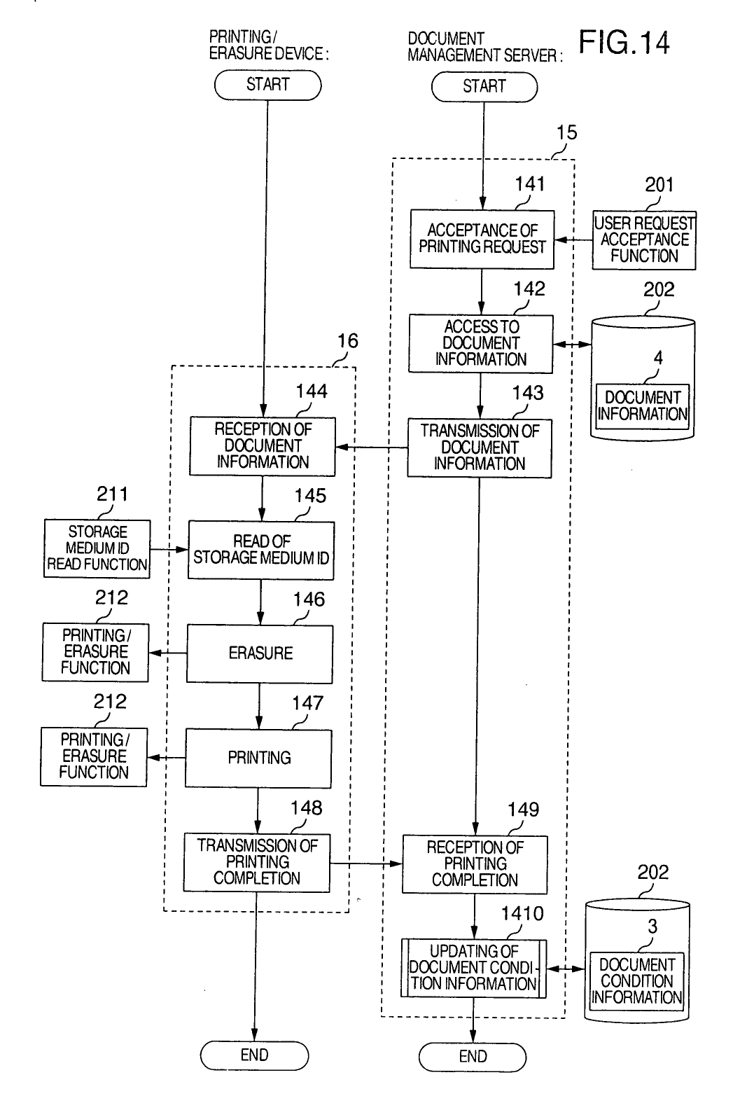

FIG. 14 is a flowchart useful for explaining the detail of the processing of the steps 15 and 16 explained with reference to the flow of FIG. 1 and this processing will be explained next. This processing involves the steps of transmitting an erasure request of printing information of the reversible storage medium 250 and a printing request of new information from the document management server 200 to the printing/erasure device 210, receiving the event of erasure completion and the event of printing completion from the printing/erasure device 210, updating the document condition information 3, executing erasure and printing corresponding to the erasure request of printing information and the printing request of the new information that are received by the printing/erasure device 210 and transmitting the event of erasure completion and the event of printing completion to the document management server 200.

(1) The document management server 200 receives an erasure instruction for erasing the document on the reversible storage medium, a printing instruction of a new document and information saved in the storage function portion 202, for retrieving the document information of the new document, such as the file name of the document, from the user request acceptance function portion 201 (step 141).

(2) The document management server 200 gains access to the document from the document information 4 stored in the storage function portion 202 on the basis of the information received by the processing of the step 141. More concretely, the document management server 200 retrieves the document file name 41 of the document information 4 and reads out the document format 42, the document character 43, the drawing 44 and the security level 45 as the information of this document by using the document file name 41 received by the processing of the step 141 as a key (step 142).

(3) The document management server 200 transmits the printing/erasure instruction received by the processing of the step 141, the printing instruction of the new document and the information read from the storage function portion 202 by the processing of the step 142 to the printing/erasure device 210 through the communication network 240 (step 143).

(4) The printing/erasure device 210 receives the information sent from the document management server 200 by the processing of the step 143 through the communication network 240 and reads the ID of the storage medium to the printed from the recognition tag 251 by using the storage medium ID read function portion 211 (steps 144 and 145).

(5) The printing/erasure device 210 erases the information printed onto the reversible storage medium 250 and the information written by using the printing/erasure function portion 212 in accordance with the printing/erasure instruction received by the processing of the step 144 and prints the new information by using the printing/erasure function portion 212 in accordance with the printing instruction (steps 146 and 147).

(6) The printing/erasure device 21 thereafter transmits the printing/erasure completion event, the printing completion event, the storage medium ID of the reversible storage medium 250 that is erased and printed, the erasure device ID, the erasure date, the printing device ID, the printing date and the printed document file name to the document management server 200 through the communication network 240 (step 148).

(7) The document management server 200 receives the information transmitted by the processing of the step 148 through the communication network 240 and updates the information of the document condition information 3 stored in the storage function portion 202 on the basis of the information received (steps 149 and 1410).

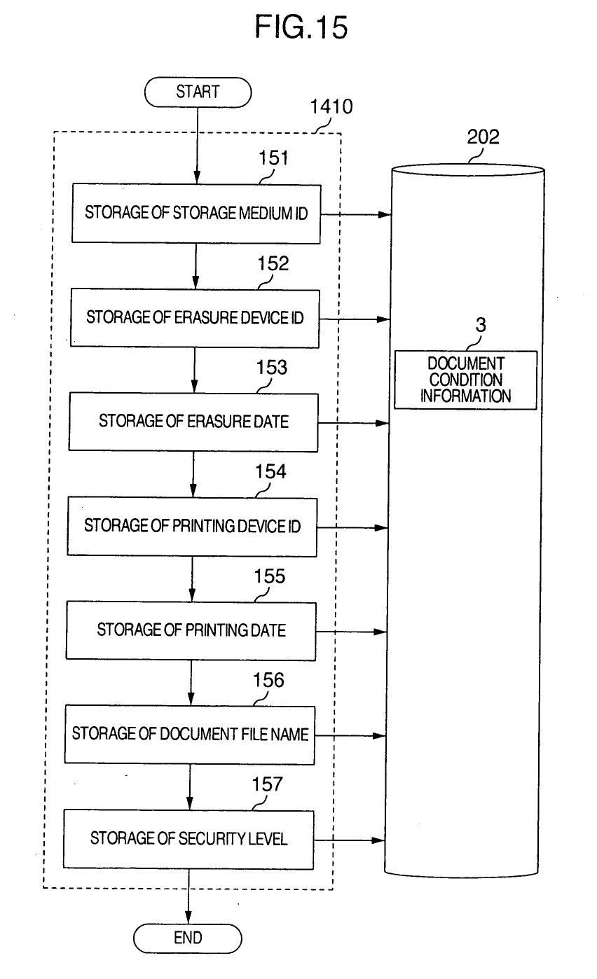

FIG. 15 is a flowchart useful for explaining the detail of the processing for updating the information of the document condition information 3 of the step 1410 explained with reference to the flow of FIG. 14 and this processing will be explained next.

(1) The document management server 200 stores the storage medium ID received by the processing of the step 148 into the storage medium ID 31 of the document condition information 3 stored in the storage function portion 202 and also stores the erasure device ID received by the processing of the step 149 into the erasure device ID 34 of the document condition information 3 (steps 151 and 152).

(2) Next, the document management server 200 stores the printing date received by the processing of the step 149 into the erasure date 35 of the document condition information 3 stored in the storage function portion 202 and the printing device ID received by the processing of the step 149 into the printing device ID 32 of the document condition information 3 stored in the storage function portion 202 (steps 153 and 154).

(3) The printing date received by the processing of the step 148 is stored in the printing date 33 of the document condition information 3 stored in the storage function portion 202 and the document file name received by the processing of the step 149 is stored in the document file name 36 of the document condition information 3 stored in the storage function portion 202 (steps 155 and 156).

(4) The document management server 200 thereafter stores the security level read in the step 142 into the security level 37 of the document file of the document condition information 3 stored in the storage function portion 202 (step 157).

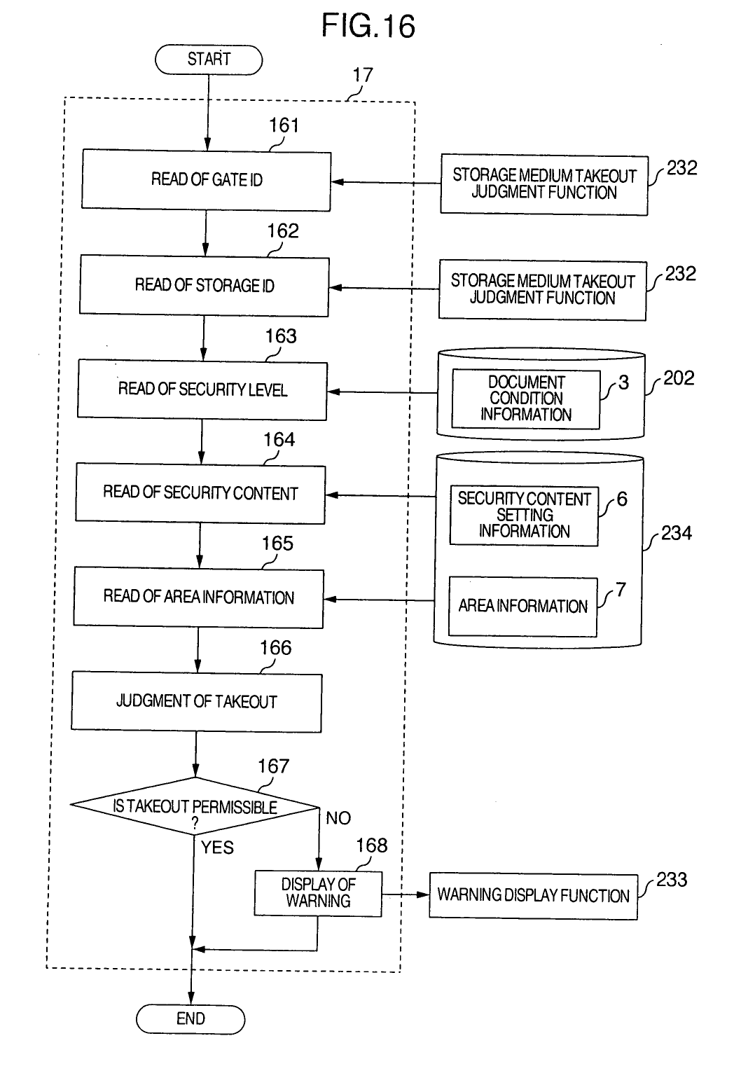

FIG. 16 is a flowchart useful for explaining the detail of the processing of the step 17 explained with reference to the flow of FIG. 1 and this processing will be explained next. This is the processing in which the printed document takeout monitor device 230 serially monitors takeout of the reversible storage medium 250 on the basis of the document condition information, judges whether or not takeout of the reversible storage medium 250 is permitted and a warning representing that takeout is not permitted is displayed when takeout is judged as impermissible.

(1) The printed document takeout monitor device 230 reads the gate ID that monitors takeout of the reversible storage medium 250 from the storage medium takeout judgment function portion 232 (step 161).

(2) The printed document takeout monitor device 230 reads the storage medium ID from the identification tag 251 attached to the reversible storage medium 250 passing through the gate of the gate ID in the step 161 by using the storage medium takeout judgment function portion 232. The storage medium ID is stored in advance in the identification tag 251. It will be assumed that “100” is read as the storage medium ID, for example (step 162).

(3) Next, the printed document takeout monitor device 230 reads the security level 310 of the entire storage medium of the document condition information 3 stored in the storage function portion 202 of the document management server 200 through the communication network 240 by using the storage medium ID read by the processing of the step 162 as a key. When the storage medium ID “100” is read in the step 162, for example, the security level of the entire storage medium is “A” in the embodiment shown in FIG. 3 (step 163).

(4) The printed document takeout monitor device 230 reads the security content 62 from the security content set information 6 saved in the storage function portion 234 of its own device by using the security level of the entire storage medium as a key. When the security level “A” of the entire storage medium is read by the processing in the step 163, for example, the security content becomes “takeout from area Y is inhibited: printing of 6 or more is inhibited” in the example shown in FIG. 6 (step 164).

(5) Next, the printed document takeout monitor device 230 reads the gate ID 72 from the area information 7 stored in the storage function portion 234 by using the security content read by the processing of the step 164 as a key. When the security content “takeout from area Y is inhibited: printing of 6 or more is inhibited” is read by the processing of the step 164, for example, the gate ID becomes “gate A, gate B” in the example shown in FIG. 7 (step 165).

(6) The storage medium takeout judgment function portion 232 judges whether or not takeout of the storage medium is permitted from the security level of the entire storage medium of the reversible storage medium 250, the security content corresponding to the security level and the ID of the gate through which the storage medium is taken out. When the gate ID read in the step 161 is “gate B”, for example, the reversible storage medium of the storage medium ID “100” is judged as “takeout is not permitted” (step 166).

(7) Whether or not takeout of the storage medium is “permitted” is judged as the result of the processing of the step 166. When the result is “permitted”, the processing of the step 17 is completed. When the result is “not permitted”, the content of “not permitted” is displayed on the warning screen by using the warning display function portion 233 (steps 167 and 168).

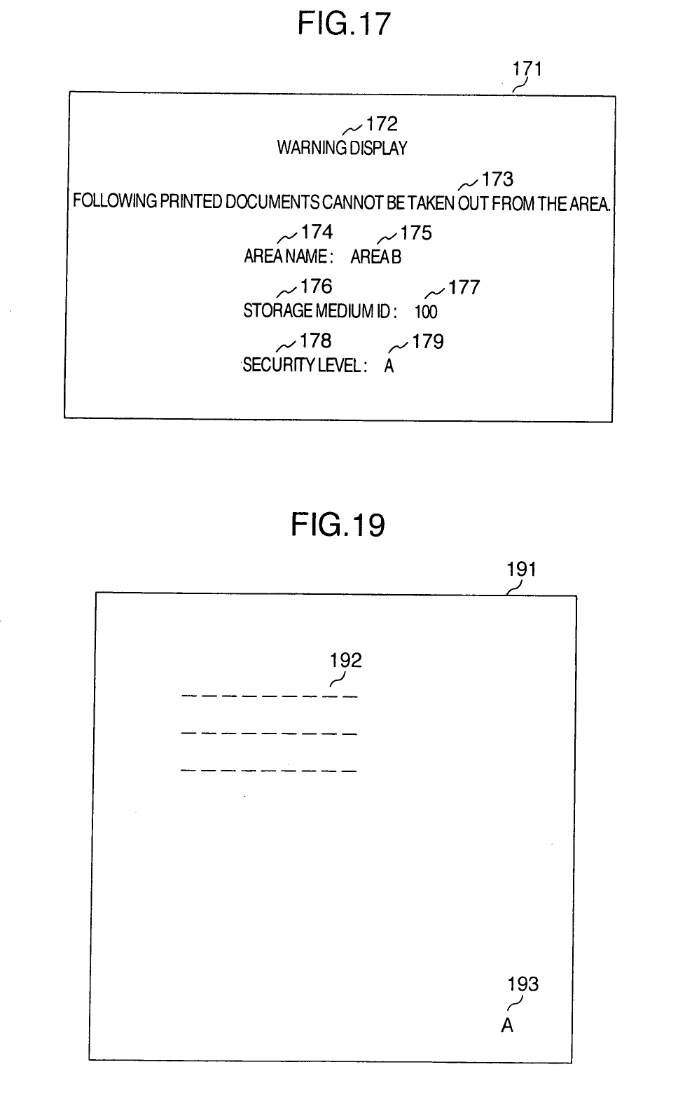

FIG. 17 shows an example of the warning screen of “takeout not permitted” displayed by using the warning display function portion 233 by the processing of the step 168 shown in FIG. 16.

As shown in FIG. 17, the example of the warning screen displays a label 172 of “warning display” inside a screen frame or window 171, a label 173 reading “following printed documents cannot be taken out from the area”, a label 174 of “area name:” an area name 175 representing from which area the reversible storage medium 250 is to be taken out, a label 176 of “storage medium ID:” an ID 177 of the storage medium to be taken out from the area, a label 177 of “security level:” and a security level 178 of the storage medium to be taken out from the area.

To manage the security of the printed document using the reversible storage medium, the embodiment of the invention described above can provide a printed document management apparatus including means for printing documents onto a surface of a storage medium, means for setting document condition information at the time of printing, means for writing information onto the storage medium surface, means for updating the document condition information at the time of write, means for rewriting the information printed onto the storage medium surface and means for updating the document condition information at the time of rewriting. Consequently, the invention can prevent information leak from the reversible storage medium.

As an additional function, the embodiment of the invention can enable a user holding the reversible storage medium to easily recognize the security level of the storage medium by printing the security level of the entire storage medium onto the reversible storage medium 250.

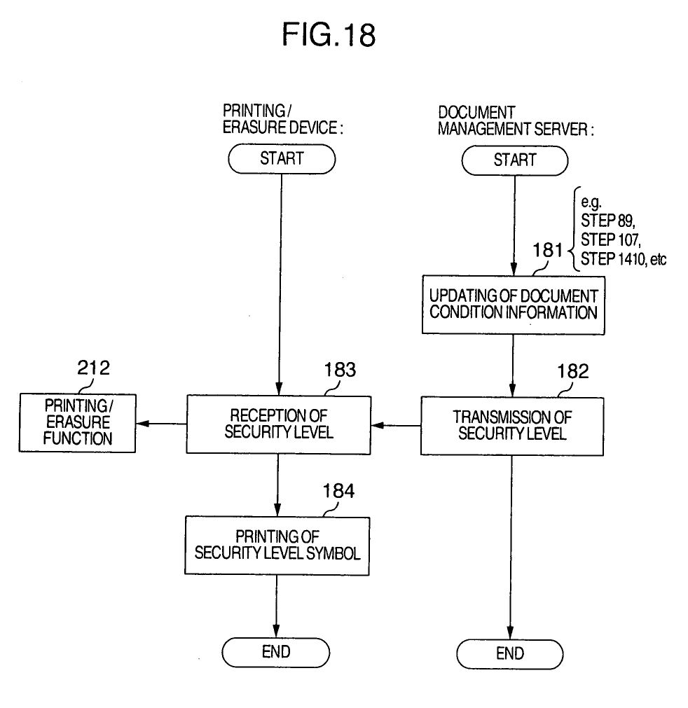

FIG. 18 is a flowchart useful for explaining the processing operation for printing the symbol of the security level onto the reversible storage medium and this processing will be explained next.

(1) The document management server 200 updates the document condition information 3 and keeps the latest information of the document state. This processing is the processing of the steps 89, 107 and 1410 of the embodiment of the invention explained above, for example (step 181).

(2) The document management server 200 reads the storage medium ID 31 of the reversible storage medium 250 updated by the processing of the step 181 of the document condition information 3 and the security level 310 of the entire storage medium and transmits these information to the printing/erasure device 210 through the communication network 240 (step 182).

(3) The printing/erasure device 210 receives the storage medium ID 31 and the security level 310 of the entire storage medium that are transmitted from the document management server 200 by the processing of the step 182 (step 183).

(4) The printing/erasure device 210 prints the symbol representing the security level capable of being identified by the user onto the reversible storage medium 250 at the time of printing or write of the reversible storage medium 250 by using the printing/erasure function portion 212 (step 184).

FIG. 19 shows a printing example of a symbol representing the security level to the reversible storage medium printed by the step 184 in the flow shown in FIG. 18.

In the printing example of the symbol representing the security level to the reversible storage medium, the content 192 of the document is printed onto the reversible storage medium 191 and a character 193 representing the security level of the entire reversible storage medium 191, that is, symbol A in the example shown in the drawing, is printed at a suitable position outside the document printing area on the reversible storage medium 191. Because the character representing the security level of the entire reversible storage medium 191 is printed in this way onto the reversible storage medium 191, the user can easily identify the security level even when the security level is changed owing to the frequent occurrence of write, and usability of the document management apparatus can be improved.

In the embodiment of the invention described above, each processing can be constituted by a program and can be executed by a CPU provided to each device. Such a program can be provided while saved in recording media such as an FD, a CDOM, a DVD, and so forth, or as digital information through a network.

It should be further understood by those skilled in the art that although the foregoing description has been made on embodiments of the invention, the invention is not limited thereto and various changes and modifications may be made without departing from the spirit of the invention and the scope of the appended claims.

1. An apparatus for managing a printed document comprising:
a storage medium capable of reversibly storing and erasing information;
a storage/erasure device for storing or erasing information to or from said storage medium;
an information management device for managing information and security of the information; and
a write device for adding information onto said storage medium,
wherein said information management device includes:
a storage device for managing information stored by said storage/erasure device to said storage medium or information added by said write device;
means for updating the information inside said storage device at the time of storage of the information or erasure of the information; and
means for updating the information inside said storage device when the information is written.

2. An apparatus for managing a printed document comprising:
a storage medium capable of reversibly storing and erasing information;
a storage/erasure device for storing or erasing information to or from said storage medium;
an information management device for managing information and security of the information; and
a write device for writing information onto said storage medium,
wherein said information management device includes:
means for holding an event of updating of the information stored by said storing/erasure device into said storage medium and a revision content owing to said updating.

3. An apparatus for managing a printed document comprising:
a storage medium capable of reversibly storing and erasing information;
a storage/erasure device for storing or erasing information to or from said storage medium;
an information management device for managing information and security of the information; and
a write device for writing information onto said storage medium,
wherein said information management device includes:
means for holding an event of updating of the information stored by said write device into said storage medium and a revision content owing to said updating.

4. An apparatus for managing a printed document according to claim 1, wherein said information management device includes means for calculating a security level of security information.

5. An apparatus for managing a printed document according to claim 4, wherein said information management device includes means for calculating a security level corresponding to security information stored or written into said storage medium.

6. An apparatus for managing a printed document according to claim 4, wherein said information management device includes means for calculating a security level of the entire storage medium as a higher security level among security information stored and written into said storage medium.

7. An apparatus for managing a printed document according to claim 4, wherein said information management device includes means for setting a security level corresponding to new security information stored when information stored in said storage medium is erased and said new information is stored.

8. An apparatus for managing a printed document according to claim 1, which stores a security level capable of being identified by people by an alphabet, a numeral or a symbol onto said storage medium.

9. An apparatus for managing a printed document according to claim 1, which divides said storage medium into a plurality of areas in accordance with storage information and write information of said storage medium, and sets a security level corresponding to each of said areas divided.

10. An apparatus for managing a printed document according to claim 1, wherein a security level is set in advance to each of said write devices.

11. An apparatus for managing a printed document according to claim 1, wherein said write device includes means for judging the security level from the information written by said write device and deciding the written security level.

12. A method for managing a printed document in an apparatus for managing a printed document, said apparatus including:
a storage medium capable of reversibly storing and erasing information;
a storage/erasure device for storing or erasing information to or from said storage medium;
an information management device for managing information and security of the information; and
a write device for writing information onto said storage medium,
said method comprising the steps of:
storing or erasing information to or from said storage medium in said storage/erasure device;
writing information into said storage medium in said write device; and
updating the information held inside at the time of storing, erasing and write of the information in said information management device.

13. A method for managing a printed document in an apparatus for managing a printed document including:
a storage medium capable of reversibly storing and erasing information;
a storage/erasure device for storing or erasing information to or from said storage medium;
an information management device for managing information and security of the information; and
a write device for writing information onto said storage medium,
said method comprising the step of:
holding an event of updating of the information applied to said storage medium by said storage/erasure device, and holding a revision content by said updating in said information management device.

14. A method for managing a printed document in an apparatus for managing a printed document including:
a storage medium capable of reversibly storing and erasing information;
a storage/erasure device for storing or erasing information to or from said storage medium;
an information management device for managing information and security of the information; and
a write device for writing information onto said storage medium,
said method comprising the steps of:
holding an event of updating of the information applied by said write device to said storage medium in said information management device and a revision content owing to said updating.

15. A method for managing a printed document according to claim 12, wherein a security level of security information is calculated in said information management device.

16. A method for managing a printed document according to claim 15, wherein a security level corresponding to each of security information stored and written to said storage medium is calculated in said information management device.

17. A method for managing a printed document according to claim 15, wherein a security level of said entire storage medium is calculated as a higher security level among security information stored and written to said storage medium in said information management device.

18. A method for managing a printed document according to claim 15, wherein a security level corresponding to new security information stored is set in said information management device when the information stored in said storage medium is erased and said new information is stored.

19. A method for managing a printed document according to claim 12, which stores a security level that can be identified by people by an alphabet, a numeral or a symbol onto said storage medium.

20. A method for managing a printed document according to claim 12, which divides said storage medium into a plurality of areas in accordance with storage information and write information of said storage medium, and sets a security level corresponding to each of said areas divided.

21. A method for managing a printed document according to claim 12, wherein a security level is set in advance to each of said write devices.

22. A method for managing a printed document according to claim 12, wherein said write device judges a security level from the information written by said write device and decides the written security level.

23. An information management apparatus for managing information and security of information stored and written to a storage medium capable of reversibly storing and erasing information, comprising:
a storage device for managing the information stored or written; and
means for updating the information inside said storage device at the time of storing of the information, write of the information or erasure of the information.

24. An information management apparatus according to claim 23, which further comprises means for calculating a security level of the security information.

25. An information management apparatus according to claim 24, which further comprises means for calculating a security level corresponding to each of the security information that is stored and written to said storage medium.

26. An information management apparatus according to claim 24, which further comprises means for calculating a security level of the entire storage medium to the highest security level from among the respective security information that is stored and written to said storage medium.

27. An information management apparatus according to claim 24, which further comprises means for setting a security level corresponding to new security information stored when the information stored in said storage medium is erased and said new information is stored.

28. An information management apparatus according to claim 23, which stores a security level that can be identified by people by an alphabet, a numeral or a symbol onto said storage medium.
